(19) United States
(12) Patent Application Publication
(10) Pub. No.: US 2024/0127472 A1
(43) Pub. Date: Apr. 18, 2024

(54) INFORMATION PROCESSING SYSTEM, IMAGE READING APPARATUS, AND NON-TRANSITORY COMPUTER READABLE MEDIUM STORING PROGRAM

(71) Applicant: FUJIFILM Business Innovation Corp., Tokyo (JP)

(72) Inventor: Manabu HAYASHI, Kanagawa (JP)

(73) Assignee: FUJIFILM Business Innovation Corp., Tokyo (JP)

(21) Appl. No.: 18/299,068

(22) Filed: Apr. 12, 2023

(30) Foreign Application Priority Data
Oct. 18, 2022 (JP) 2022-167123

(51) Int. Cl. G06T 7/70; G06V 10/74

(52) U.S. Cl. CPC G06T 7/70; G06V 10/761; G06T 2207/30176; G06V 2201/07

(57) ABSTRACT

An information processing system includes one or more processors configured to: acquire a document table video that is a video of a document table on which a document is placed and is obtained by an imaging device after the imaging device images the document table; and in a case in which the document table video includes an imaged document that is a document having been imaged by the imaging device, detect the imaged document.

### CROSS-REFERENCE TO RELATED APPLICATIONS

This application is based on and claims priority under 35 USC 119 from Japanese Patent Application No. 2022-167123 filed Oct. 18, 2022.

### BACKGROUND

### (i) Technical Field

The present invention relates to an information processing system, an image reading apparatus, and a non-transitory computer readable medium storing a program.

### (ii) Related Art

JP2019-004298A discloses a process that associates first and second image data items as front and back image data items for each region in a case in which one side of each of a plurality of documents placed in each of a plurality of predetermined regions of a document placement table is collectively read to generate a plurality of first image data items, the front and back sides of the plurality of documents are reversed, and the opposite sides of the plurality of documents re-placed in the plurality of regions are collectively read to generate a plurality of second image data items.

### SUMMARY

In a document reading apparatus, in some cases, a document to be read is placed on a document table and is then read.

Here, in the document reading apparatus, a situation may occur in which, after a document is read, the document that has already been read is read again without being removed. Further, in a case in which images are formed on the front and back sides of a document, a situation may occur in which, after first reading is performed on the document, second reading is performed without the user reversing the front and back sides of the document. This situation is more likely to occur in a case in which a plurality of small documents, such as business cards or receipts, are placed on the document table at the same time.

Aspects of non-limiting embodiments of the present disclosure relate to an information processing system, an image reading apparatus, and a non-transitory computer readable medium storing a program that improve workability in a case in which a user reads a document, as compared to a configuration in which a document that has been read is not detected.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including one or more processors configured to: acquire a document table video that is a video of a document table on which a document is placed and is obtained by an imaging device after the imaging device images the document table; and in a case in which the document table video includes an imaged document that is a document having been imaged by the imaging device, detect the imaged document.

### BRIEF DESCRIPTION OF THE DRAWINGS

Exemplary embodiment(s) of the present invention will be described in detail based on the following figures, wherein:

FIG. 1 is a diagram showing an overall configuration of an image reading apparatus;

FIG. 2 is a diagram showing a hardware configuration of an information processing apparatus;

FIGS. 3A and 3B are diagrams showing an example of display of a display device;

FIGS. 4A and 4B are diagrams showing another example of the display of the display device;

FIGS. 5A and 5B are diagrams showing still another example of the display of the display device;

FIGS. 6A and 6B are diagrams showing yet another example of the display of the display device;

FIGS. 7A and 7B are diagrams showing still yet another example of the display of the display device;

FIG. 8 is a flowchart showing details of a process in a case in which the process is performed;

FIG. 9 is a diagram showing yet still another example of the display of the display device;

FIG. 10 is a flowchart showing details of a process in a case in which the process is performed;

FIGS. 11A and 11B are diagrams showing still yet another example of the display of the display device;

FIGS. 12A, 12B, and 12C are diagrams showing yet still another example of the display of the display device; and

FIG. 13 is a diagram showing an image forming apparatus.

### DETAILED DESCRIPTION

Hereinafter, an exemplary embodiment of the invention will be described in detail with reference to the accompanying drawings.

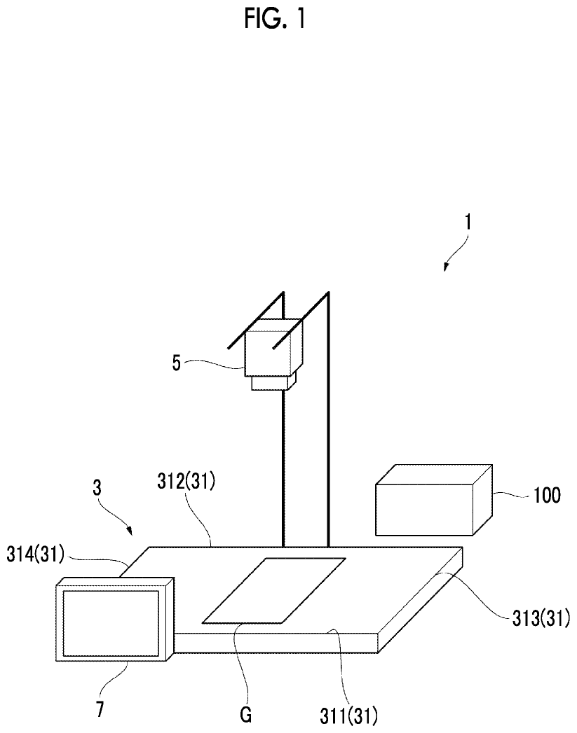

FIG. 1 is a diagram showing an overall configuration of an image reading apparatus 1.

The image reading apparatus 1 according to the present exemplary embodiment is a so-called document camera.

The image reading apparatus 1 is provided with a document table 3 on which a document G whose image is to be read is placed and which supports the document G from below, a camera 5 as an example of an imaging device that images the document G placed on the document table 3, and a display device 7 that displays information to a user.

The image reading apparatus 1 is an apparatus that images the document table 3 having the document G placed thereon and reads the document G.

Further, the image reading apparatus 1 is provided with an information processing apparatus 100 that processes information related to the imaging of the document G. The information processing apparatus 100 is connected to the camera 5 and the display device 7 through a communication line (not shown). The information processing apparatus 100 makes various determinations related to the reading of the document G, which will be described below.

The camera 5 is disposed above the document table 3 with a gap between the camera 5 and the document table 3. The camera 5 comprises an imaging element, such as a charge coupled device (CCD), and images the document table 3 that is located below the camera 5. In the present exemplary embodiment, the document table 3 falls within the angle of view of the camera 5, and the camera 5 images the entire document table 3.

The display device 7 is configured by, for example, a liquid crystal display or an organic EL display and displays information notified to the user who operates the image reading apparatus 1.

In the present exemplary embodiment, the display device 7 is configured by a so-called touch panel. The display device 7 receives an operation of the user in addition to displaying information.

The document table 3 is formed in a rectangular shape and has four sides 31. In the present exemplary embodiment, a front side 311, a back side 312, a right side 313, and a left side 314 are provided as the four sides 31.

In a case in which the user operates the image reading apparatus 1, the user is positioned in front of the front side 311. In other words, in the present exemplary embodiment, the user is positioned on a side that is opposite to the side on which the back side 312 is positioned such that the front side 311 is interposed between the sides.

In the present exemplary embodiment, in a case in which the information processing apparatus 100 receives an instruction from the user in a state in which the document G is placed on the document table 3, the information processing apparatus 100 operates the camera 5 to image the document table 3 on which the document G is placed. Therefore, a captured image which is a still image of the document G is acquired. Then, an acquisition process of extracting and acquiring a document image, which is a portion in which the document G is read, from the captured image is performed.

In the acquisition process of extracting and acquiring the document image, for example, a rectangular image included in the captured image is detected. Then, the rectangular image is acquired as the document image.

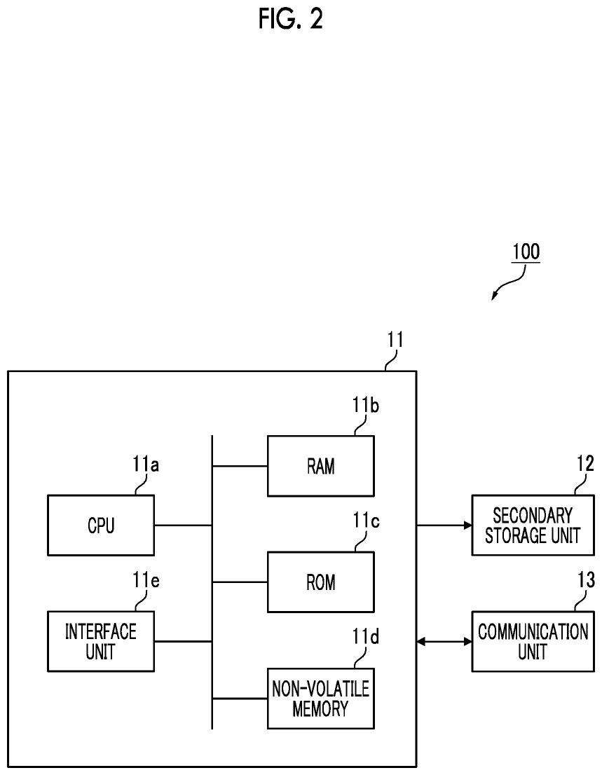

FIG. 2 is a diagram showing a hardware configuration of the information processing apparatus 100.

The information processing apparatus 100 includes an arithmetic processing unit 11 that performs digital arithmetic processing according to a program, a secondary storage unit 12 on which information, such as a program, is recorded, and a communication unit 13 that transmits and receives information to and from an external apparatus.

The secondary storage unit 12 is implemented by an existing information storage device such as a hard disk drive (HDD), a semiconductor memory, or a magnetic tape.

The arithmetic processing unit 11 is provided with a CPU 11a as an example of a processor. In the present exemplary embodiment, the CPU 11a performs each process which will be described below.

In addition, the arithmetic processing unit 11 comprises a RAM 11b that is used as a work memory or the like of the CPU 11a and a ROM 11c in which programs or the like executed by the CPU 11a are stored.

In addition, the arithmetic processing unit 11 comprises a non-volatile memory 11d that is configured to be rewritable and can hold data even in a case in which power supply is interrupted and an interface unit 11e that controls each unit, such as the communication unit 13, connected to the arithmetic processing unit 11.

The non-volatile memory 11d is configured by, for example, an SRAM or a flash memory that is backed up by a battery.

In the present exemplary embodiment, the arithmetic processing unit 11 reads the program stored in the secondary storage unit 12 or the ROM 11c to perform each process which will be described below.

The arithmetic processing unit 11, the secondary storage unit 12, and the communication unit 13 are connected to each other through a bus or a signal line.

The program executed by the CPU 11a can be provided to the information processing apparatus 100 in a state in which the program is stored in a computer-readable recording medium such as a magnetic recording medium (for example, a magnetic or a magnetic disk), an optical recording medium (for example, an optical disk), a magneto-optical recording medium, or a semiconductor memory. Further, the program executed by the CPU 11a may be provided to the information processing apparatus 100 by a communication unit such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

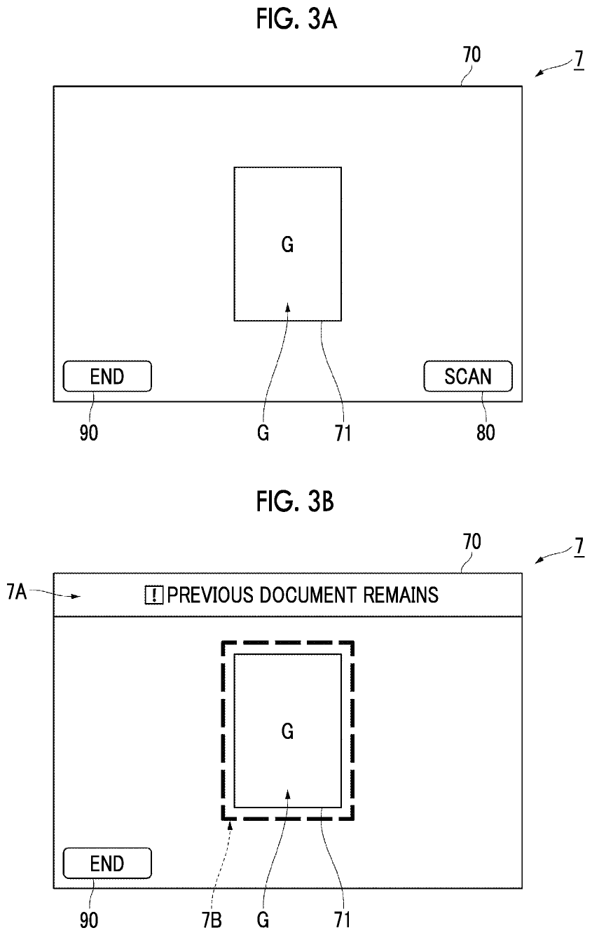

The process performed by the image reading apparatus 1 will be described with reference to FIGS. 3A and 3B.

FIGS. 3A and 3B are diagrams showing an example of the display of the display device 7.

In the present exemplary embodiment, in a case in which the image reading apparatus 1 (see FIG. 1) is turned on, the acquisition of a video by the camera 5 (see FIG. 1) is started, and the video acquired by the camera 5 is displayed on the display device 7.

In the example of the display shown in FIG. 3A, a document table video 70, which is a video of the document table 3 obtained by imaging the entire document table 3 with the camera 5, is displayed on the display device 7. The document table video 70 is a motion picture. In other words, the document table video 70 is a video obtained by imaging the document table 3 in real time.

In a case in which the document G (see FIG. 1) is placed on the document table 3 (see FIG. 1), the video of the document table 3 on which the document G is placed is displayed as the document table video 70 as shown in FIG. 3A.

A corresponding image 71 is displayed on the display device 7. The corresponding image 71 is an image corresponding to the document G placed on the document table 3 in the document table video 70.

Further, in the present exemplary embodiment, as shown in FIG. 3A, a scan button 80 and an end button 90 are displayed as button images, which are images for receiving instructions from the user, on the display device 7.

The scan button 80 is a button image for receiving an instruction to acquire a captured image (which will be described below), which is a still image, from the user. In other words, the scan button 80 is a button image for receiving an instruction to capture a still image of the document table 3 from the user.

The end button 90 is a button image for receiving an instruction to end the imaging of the document table 3 by the camera 5 from the user. In other words, the end button 90 is a button image for receiving an instruction to end the imaging of the document table 3 without capturing the still image of the document table 3 from the user.

In the reading of the document G by the image reading apparatus 1, first, the document G is placed on the document table 3. In this case, in the present exemplary embodiment, as shown in FIG. 3A, the document table video 70 obtained by the camera 5 is displayed on the display device 7.

Then, the user operates the scan button 80 to direct the camera 5 to perform imaging. Therefore, a captured image obtained by imaging the document table 3 on which the document G is placed is acquired.

Then, in the present exemplary embodiment, the acquisition process of extracting and acquiring the document image, which is a portion in which the document G is read, from the captured image is performed.

In the present exemplary embodiment, the entire document table 3 is imaged by the camera 5, and the captured image includes not only the image of the document G but also the image of the document table 3.

In the present exemplary embodiment, as described above, the acquisition process of extracting and acquiring the document image, which is a portion in which the document G is read, from the captured image is performed.

Here, the document G which has been imaged and whose document image has been acquired (hereinafter, referred to as an “imaged document G”) is an example of an imaged document. In other words, the read document G is an example of the imaged document.

In the present exemplary embodiment, even after the captured image is acquired, the imaging with the camera 5 is continued, and the document table video 70 is sequentially acquired.

Then, in the present exemplary embodiment, in a case in which the document G that has already been read is continuously present in the acquired document table video 70, the document G is detected.

In a case in which the user operates the end button 90, the imaging with the camera 5 is ended. Therefore, the detection of the document G that has already been read is ended.

In FIG. 3B, the document table video 70 after a period of time has elapsed since the end of the reading of the document G is displayed.

In the present exemplary embodiment, as shown in FIG. 3B, in a case in which the document table video 70 includes the image of the document G that has been read, the document G is detected.

In the present exemplary embodiment, in a case in which the imaged document G still remains on the document table 3, the corresponding image 71 that corresponds to the document G is detected from the document table video 70.

Further, in the present exemplary embodiment, in a case in which the imaged document G still remains on the document table 3, a process for making the user recognize that the document G remains on the document table 3 is performed.

Specifically, as represented by reference numeral 7A in FIG. 3B, a message “previous document remains” is displayed.

In other words, in a case in which the imaged document G still remains on the document table 3, a notification informing the user that the document G remains on the document table 3 is issued.

In addition, in a case in which the imaged document G still remains on the document table 3, as represented by reference numeral 7B in FIG. 3B, another image may be attached to the corresponding image 71 that corresponds to the document G. Further, in a case in which the imaged document G still remains on the document table 3, the notification may be issued using, for example, a picture, sound, or light.

In addition, in a case in which the imaged document G still remains on the document table 3, new imaging with the camera 5 may not be performed.

Specifically, for example, as shown in FIG. 3B, the scan button 80 (see FIG. 3A) for receiving an imaging instruction from the user may not be displayed such that the user does not issue an instruction to the camera 5 and new imaging with the camera 5 is not performed.

In the present exemplary embodiment, the instruction to acquire the captured image, which is a still image, is received through the scan button 80. However, for example, the scan button 80 may not be displayed such that new imaging with the camera 5 is not performed.

In a case in which the imaging instruction is received from the user through an operation on the scan button 80, the scan button 80 is not displayed temporarily. In other words, in a case in which the document G is imaged by the camera 5, the scan button 80 is not displayed until the document G is removed from the document table 3.

In addition, in a case in which the imaged document G still remains on the document table 3, the imaging instruction may be received from the user through the scan button 80 once, but new imaging with the camera 5 may not be performed.

Specifically, for example, the imaging instruction may be received from the user, but imaging based on this instruction may be suspended until the imaged document G is removed from the document table 3. Then, after the imaged document G is removed from the document table 3, the imaging based on this instruction may be performed.

In addition, new imaging with the camera 5 may be performed in a state in which the imaged document G still remains on the document table 3, but a document image may not be acquired from the captured image obtained by this imaging.

In the present exemplary embodiment, the CPU 11a detects the imaged document G on the basis of the document table video 70. In other words, the CPU 11a detects the document G remaining on the document table 3 on the basis of the document table video 70.

In the example shown in FIGS. 3A and 3B, in a case in which the document table video 70 obtained by imaging the document table 3 (see FIG. 1) includes the corresponding image 71 corresponding to the imaged document G, the document G is detected.

The CPU 11a detects the document G remaining on the document table 3 on the basis of the document image included in the captured image obtained as a still image and the corresponding image 71 included in the document table video 70 obtained in real time.

Specifically, the CPU 11a detects the imaged document G in a case in which the position of the document image included in the captured image obtained as a still image is matched with the position of the corresponding image 71 included in the document table video 70 obtained in real time. In other words, in this case, the CPU 11a detects the document G remaining on the document table 3.

In the present exemplary embodiment, in a case in which the imaged document G remains on the document table 3, the document table video 70 obtained in real time includes a rectangular image caused by the document G.

Further, in the present exemplary embodiment, the captured image obtained as a still image also includes the rectangular image caused by the document G.

In a case in which the position of the rectangular image included in the document table video 70 is matched with the position of the rectangular image included in the captured image, the CPU 11a determines that the document G remains and detects the imaged document G.

In addition, in the acquisition of information related to the position of the image, for example, the position of each of four corners of the image is acquired. In a case in which the position of each of four corners of the rectangular image included in the captured image is matched with the position of each of four corners of the rectangular image included in the document table video 70, it is determined that the document G remains on the document table 3.

Further, in the acquisition of the information related to the position of the image, for example, the position of a central portion of the rectangular image is acquired. Then, in a case in which the position of the central portion of the rectangular image included in the captured image is matched with the position of the central portion of the rectangular image included in the document table video 70, it is determined that the document G remains on the document table 3.

In addition, for example, in a case in which an image included in the captured image, which is a still image, is matched with an image included in the document table video 70, the CPU 11a determines that the document G remains on the document table 3.

In this configuration, even in a case in which the document G is moved on the document table 3 after the document G is imaged, it is determined that the document G remains on the document table 3.

Further, the CPU 11a may detect the imaged document G, for example, on the basis of only the document table video 70. In other words, the CPU 11a may detect the document G remaining on the document table 3 on the basis of only the document table video 70.

In a case in which this process is performed, the CPU 11a determines whether or not the document G placed on the document table 3 has been moved to the outside of the document table 3 over the periphery of the document table 3 on the basis of the document table video 70 after the acquisition of the captured image.

Specifically, in a case in which an image corresponding to the document G is continuously present in the document table video 70 after imaging is performed by the camera 5, the CPU 11a determines that the imaged document G has not been moved to the outside of the document table 3 over the periphery of the document table 3.

In this case, the CPU 11a determines that the document G remains on the document table 3.

In addition, in the detection of the imaged document G, the CPU 11a may combine the above-described processes to detect the document G remaining on the document table 3.

Specifically, for example, the CPU 11a may detect the document G remaining on the document table 3 on the basis of the position of the rectangular image included in the captured image and an image formed in the rectangular image, and the position of the rectangular image included in the document table video 70 and an image formed in the rectangular image.

In this case, for example, the CPU 11a detects the document G remaining on the document table 3 in a case in which the position of the rectangular image included in the captured image and the image formed in the rectangular image are matched with the position of the rectangular image included in the document table video 70 and the image formed in the rectangular image, respectively.

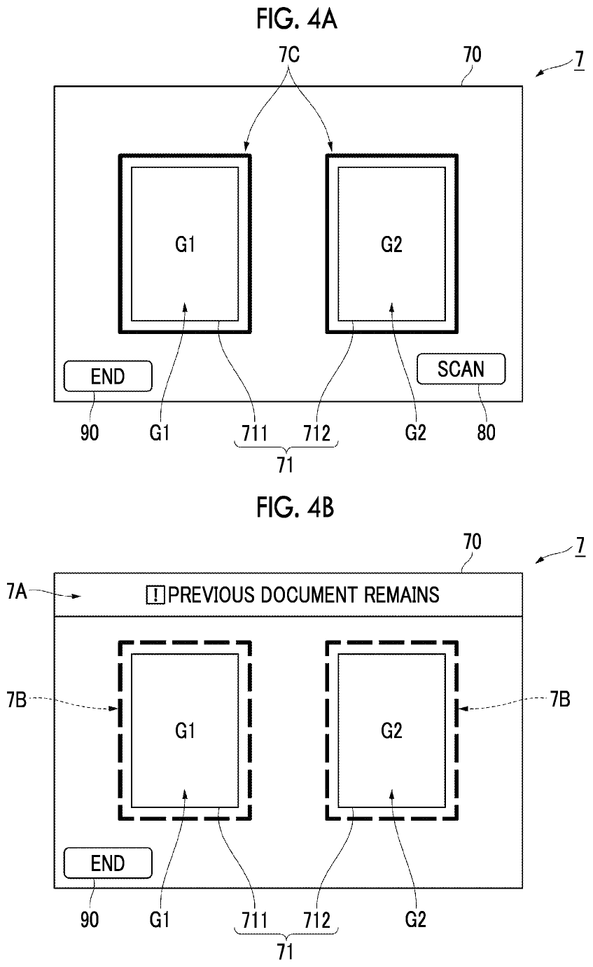

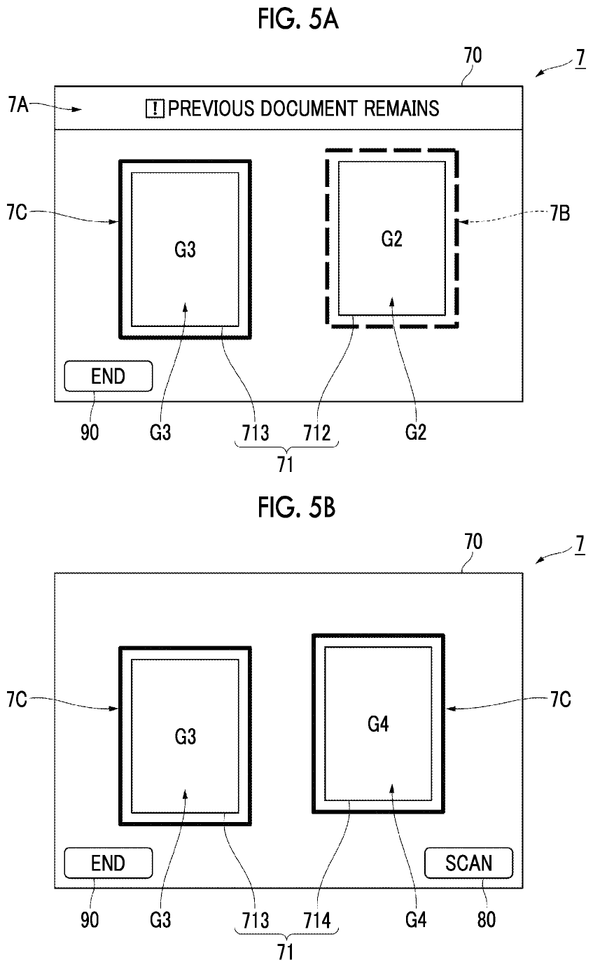

FIGS. 4A and 4B and FIGS. 5A and 5B (diagrams showing another example of the display of the display device 7) are diagrams showing a process performed in a case in which the user replaces and reads documents.

In this example of the process, a case in which, after documents G1 and G2 are imaged, documents G3 and G4 are imaged is given as an example.

FIG. 4A is a diagram showing a state before a captured image is acquired, and FIG. 4B is a diagram showing a state after the captured image is acquired.

FIG. 5A is a diagram showing a state in which the imaged document G1 is removed from FIG. 4B and a new document G3 is placed on the document table 3, and FIG. 5B is a diagram showing a state in which the imaged document G2 is removed from FIG. 5A and a new document G4 is placed on the document table 3.

In this example of the process, first, the documents G1 and G2 are placed on the document table 3 (see FIG. 1) by the user, and the document table video 70 is in the state shown in FIG. 4A. The document table video 70 includes corresponding images 711 and 712 which correspond to the documents G1 and G2, respectively.

In the example of the display shown in FIG. 4A, in addition to the corresponding images 711 and 712, images surrounding each of the corresponding images 71 (711 and 712) are displayed as represented by reference numeral 7C.

The surrounding images represented by the reference numeral 7C are images for notifying the user that the document images of the documents G1 and G2 have not been extracted and acquired from the captured image.

In the present exemplary embodiment, as described above, the document image is extracted and acquired from the captured image obtained by imaging the entire document table 3.

The surrounding images represented by the reference numeral 7C are images indicating that the document images of the documents G1 and G2 have not been extracted and acquired from the captured image.

In addition, the image represented by the reference numeral 7C is not limited to the form surrounding the corresponding image 71 and may be, for example, an image of an arrow or an image of a text message such as a pop-up message.

Then, in this example of the process, the documents G1 and G2 are imaged.

Specifically, in a case in which the scan button 80 is selected by the user, the document table 3 on which the documents G1 and G2 are placed is imaged.

Then, even in this example of the process, the imaged documents G1 and G2 are detected from the document table video 70. Then, display indicating that the documents G1 and G2 remain on the document table 3 is performed as represented by reference numeral 7A in FIG. 4B.

In the example of the display shown in FIG. 4B, in addition to the document table video 70, a message “previous document remains” is displayed as represented by the reference numeral 7A.

In other words, in the example of the display shown in FIG. 4B, a notification informing the user that the imaged documents G1 and G2 remain on the document table 3 is issued.

In addition, a notification informing the user that the imaged documents G1 and G2 remain on the document table 3 may be issued by, for example, a picture, sound, or light.

Further, in the example of the display shown in FIG. 4B, images that surround each of the corresponding images 71 (711 and 712) are displayed as represented by reference numeral 7B.

The surrounding images represented by the reference numeral 7B are images for notifying the user that the document images corresponding to the documents G1 and G2 have already been extracted and acquired from the captured image.

In the present exemplary embodiment, in a case in which the documents G1 and G2 are imaged, a process of acquiring the document images is started. However, in a state in which the document images are acquired by this acquisition process, the surrounding images represented by the reference numeral 7B are displayed.

In addition, similarly to the above, the image for notifying the user that the document image has been acquired is not limited to the surrounding image and may be, for example, an image of an arrow or an image of a text message such as a pop-up message.

Further, in the example of the display shown in FIG. 4B, the scan button 80 (see FIG. 4A) for receiving a new imaging instruction from the user is not displayed such that new imaging with the camera 5 is not performed.

In addition, the display of the scan button 80 may be maintained, and an instruction for the scan button 80 may be received from the user. However, in this case, as described above, new imaging with the camera 5 is suspended until the documents G1 and G2 are removed from the document table 3.

In the example of the display shown in FIG. 4B, the document table video 70 including the corresponding images 71 which correspond to each of the documents G1 and G2 is displayed.

Then, in this example of the process, the user removes the document G1 and places the new document G3 on the document table 3.

In this case, as shown in FIG. 5A, the document table video 70 including a corresponding image 713 which corresponds to the new document G3 is displayed.

In the example of the display shown in FIG. 5A, the document table video 70 includes the corresponding image 712 corresponding to the imaged document G2 and the corresponding image 713 corresponding to the new document G3.

In this case, since the imaged document G2 still remains on the document table 3, a message “previous document remains” is displayed as represented by the reference numeral 7A in FIG. 5A.

In other words, a notification informing the user that the imaged document G2 remains on the document table 3 is issued.

In addition, the notification informing the user that the imaged document G2 remains on the document table 3 may be issued by, for example, a picture, sound, or light.

Further, in the example of the display shown in FIG. 5A, the imaged document G2 and the new document G3 are displayed to be identifiable.

In the example of the display shown in FIG. 5A, the display aspect of the imaged document G2 is different from the display aspect of the new document G3. Therefore, the user can identify the imaged document G2 and the new document G3.

In the example of the display shown in FIG. 5A, a broken line image represented by the reference numeral 7B is attached to the corresponding image 712 which corresponds to the imaged document G2, and a solid line image represented by reference numeral 7C is attached to the corresponding image 713 which corresponds to the new document G3.

In addition, for example, the imaged document G2 may be displayed to be blinked, and the new document G3 may be displayed not to be blinked.

Further, for example, a display color of the imaged document G2 may be different from a display color of the new document G3.

Furthermore, for example, the imaged document G2 may be displayed, and the new document G3 may not be displayed.

In addition, in the example of the display shown in FIG. 5A, similarly to the above, the scan button 80 (see FIG. 4A) for receiving a new imaging instruction from the user is not displayed such that new imaging with the camera 5 is not performed.

Then, in this example of the process, the user removes the document G2 and places a new document G4 on the document table 3 instead of the document G2.

In this case, as shown in FIG. 5B, the document table video 70 including the corresponding images 713 and 714 which correspond to the new documents G3 and G4, respectively, is displayed.

In the example of the display shown in FIG. 5B, images represented by the reference numeral 7C are displayed for the corresponding images 713 and 714 which correspond to the new documents G3 and G4, respectively.

Similarly to the above, the images represented by the reference numeral 7C are images for notifying the user that the document images of the documents G3 and G4 have not been extracted and acquired from the captured image.

In the state shown in FIG. 5B, since the new documents G3 and G4 placed on the document table 3 have not been imaged, the message “previous document remains” is not displayed.

In a state in which the new documents G3 and G4 have not been imaged, the scan button 80 is displayed as shown in FIG. 5B. Therefore, a new imaging instruction is received from the user such that new imaging with the camera 5 is performed.

In the state shown in FIG. 5A, since the imaged document G2 remains on the document table 3, the scan button 80 is not displayed, and it is not possible to receive a new imaging instruction from the user.

In the state shown in FIG. 5B, since the imaged document G2 does not remain on the document table 3, the scan button 80 is displayed such that the user can issue a new imaging instruction.

Therefore, the new documents G3 and G4 can be imaged.

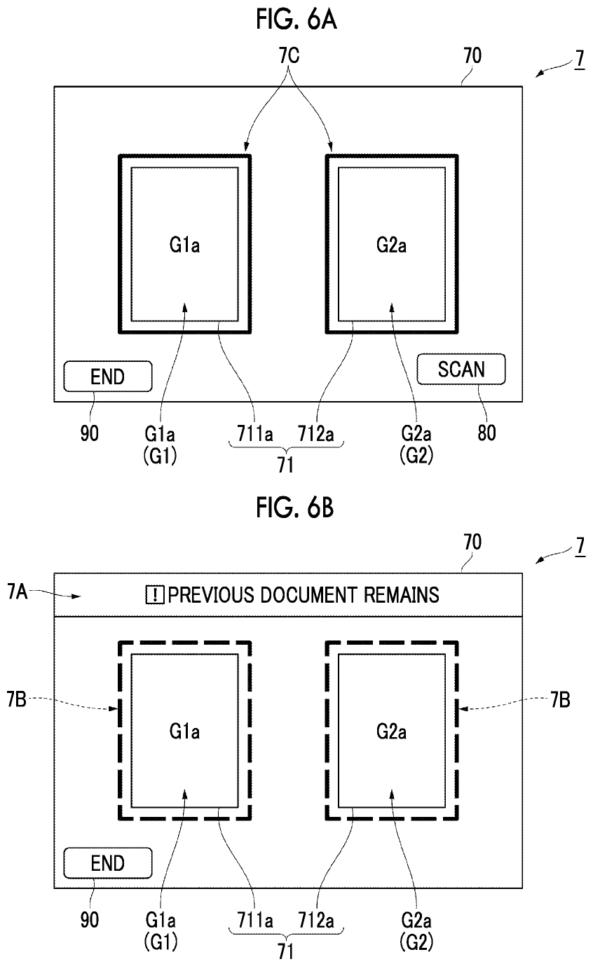

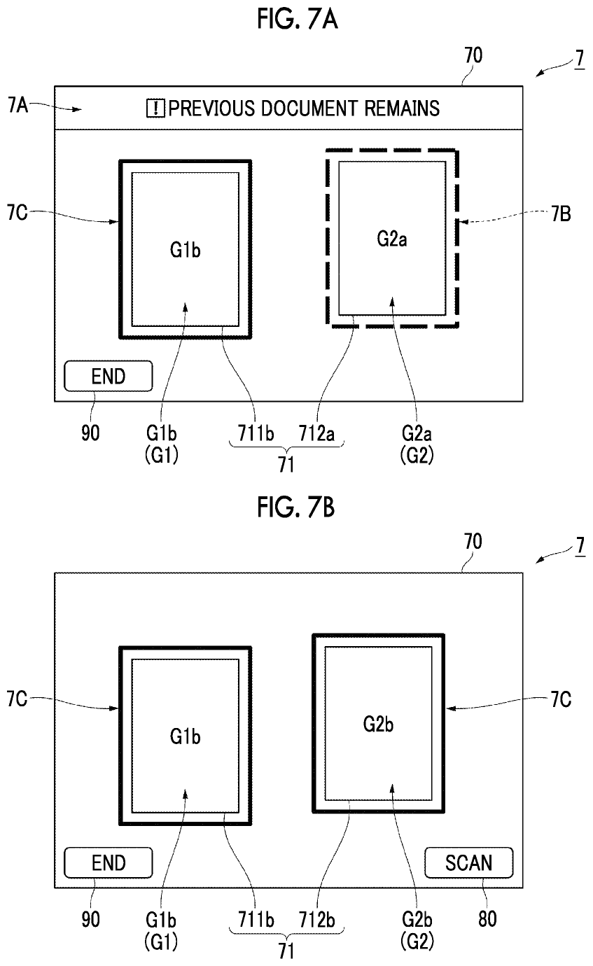

FIGS. 6A and 6B and FIGS. 7A and 7B (diagrams showing another example of the display of the display device 7) are diagrams showing a process performed in a case in which the user reverses the front and back sides of the documents for reading.

In this example of the process, a case in which the documents G1 and G2 having images formed on both the front and back sides are imaged is given as an example.

FIG. 6A is a diagram showing a state before a captured image of front sides G1a and G2a of the documents G1 and G2 is acquired, and FIG. 6B is a diagram showing a state after the captured image of the front sides G1a and G2a of the documents G1 and G2 is acquired.

FIG. 7A is a diagram showing a state in which the front and back sides of the imaged document G1 are reversed, and FIG. 7B is a diagram showing a state in which the front and back sides of the imaged document G2 are reversed.

In this example of the process, first, as shown in FIG. 6A, the document table video 70 including a video of the documents G1 and G2 placed on the document table 3 (see FIG. 1) with the front sides G1a and G2a facing the camera 5 (see FIG. 1) is displayed on the display device 7.

The document table video 70 includes corresponding images 711a and 712a which correspond to the documents G1 and G2 placed on the document table 3 with the front sides G1a and G2a facing the camera 5, respectively.

In the example of the display shown in FIG. 6A, similarly to the above, in addition to the corresponding images 711a and 712a, images that surround each of the corresponding images 71 (711a and 712a) are displayed as represented by the reference numeral 7C.

The surrounding images represented by the reference numeral 7C are images for notifying the user that the document images of the front sides G1a and G2a of the documents G1 and G2 have not been extracted and acquired from the captured image.

Then, in this example of the process, the user selects the scan button 80. Therefore, the captured image obtained by imaging the front sides G1a and G2a of the documents G1 and G2 is acquired.

Then, the document images of the front sides G1a and G2a of the documents G1 and G2 are extracted and acquired from the captured image.

Then, even in this example of the process, the imaged documents G1 and G2 are detected from the document table video 70 by the same process as described above.

Therefore, even in this example of the process, as shown in FIG. 6B, information indicating that the documents G1 and G2 still remain on the document table 3 is displayed on the display device 7.

Even in this example of the process, as represented by the reference numeral 7A in FIG. 6B, information indicating that “previous document remains” is displayed as the information indicating that the documents G1 and G2 still remain on the document table 3.

Further, in the example of the display shown in FIG. 6B, similarly to the above, the scan button 80 (see FIG. 6A) for receiving a new imaging instruction from the user is not displayed such that new imaging with the camera 5 is not performed.

Furthermore, even in this example of the process, as represented by the reference numeral 7B in FIG. 6B, images that surround each of the corresponding images 71 (711 and 712) are displayed.

Similarly to the above, the images represented by the reference numeral 7B are images for notifying the user that the document images corresponding to the front sides G1a and G2a of the documents G1 and G2 have already been extracted and acquired from the captured image.

Then, in this example of the process, the user reverses the front and back sides of the document G1 of the imaged documents G1 and G2 such that a back side G1b of the document G1 faces the camera 5 (see FIG. 1).

Then, as shown in FIG. 7A, the document table video 70 including a corresponding image 711b which corresponds to the document G1 placed with the back side G1b facing the camera 5 is displayed.

In the example of the display shown in FIG. 7A, the document table video 70 includes the corresponding image 712a corresponding to the front side G2a of the imaged document G2 and the corresponding image 711b corresponding to the back side G1b of the document G1.

In this case, as the imaged document, the document G2 placed with the front side G2a facing the camera 5 is detected from the document table video 70.

Further, in this case, as represented by the reference numeral 7A in FIG. 7A, the message “previous document remains” is displayed to notify the user that the imaged document G2 in which one side has been imaged remains on the document table 3.

Furthermore, even in this example of the process, display is performed such that the document G1 placed with the back side G1b facing the camera 5 and the document G2 placed with the front side G2a facing the camera 5 can be identified.

Specifically, in the example of the display shown in FIG. 7A, a solid line image represented by the reference numeral 7C is attached to the corresponding image 711b which corresponds to the document G1 placed with the back side G1b facing the camera 5, and a broken line image represented by the reference numeral 7B is attached to the corresponding image 712a which corresponds to the document G2 placed with the front side G2a facing the camera 5.

Then, in this example of the process, the user reverses the front and back sides of the imaged document G2 such that the back side G2b of the document G2 faces the camera 5 (see FIG. 1).

In this case, as shown in FIG. 7B, the document table video 70 including a corresponding image 712b which corresponds to the back side G2b of the document G2 is displayed.

In the state shown in FIG. 7B, since the back sides G1b and G2b of the documents G1 and G2 placed on the document table 3 have not been imaged, the message “previous document remains” is not displayed.

In a state in which the back sides G1b and G2b of the documents G1 and G2 have not been imaged, the scan button 80 is displayed as shown in FIG. 7B. Therefore, a new imaging instruction is received from the user such that new imaging with the camera 5 is performed.

In the state shown in FIG. 7A, since the document G2 in which the front side G2a that has been imaged faces the camera 5 remains on the document table 3, the scan button 80 is not displayed, and it is not possible to receive a new imaging instruction from the user.

In the state shown in FIG. 7B, the document G2 in which the back side G2b faces the camera 5 instead of the front side G2a that has been imaged is placed. Therefore, the scan button 80 is displayed, and the user can issue a new imaging instruction.

Therefore, the back sides G1b and G2b of the documents G1 and G2 can be imaged.

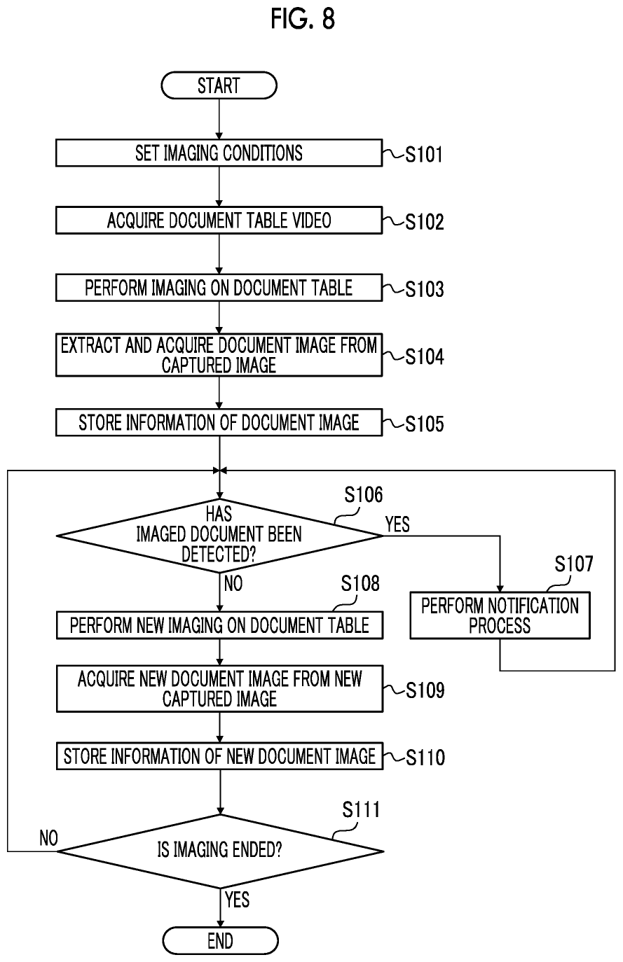

FIG. 8 is a flowchart showing a flow of the above-described process.

In the present exemplary embodiment, first, the CPU 11a receives the setting of imaging conditions (Step S101). Specifically, for example, the CPU 11a receives the setting of the imaging conditions in a case in which the user turns on the image reading apparatus 1 (see FIG. 1) and performs an operation on the display device 7.

Then, the CPU 11a operates the camera 5 and starts to acquire the document table video 70 obtained by imaging the document table 3 (Step S102). Then, the document table video 70 which is a motion picture showing the current state of the entire document table 3 is displayed on the display device 7.

Then, in this example of the process, the user places the document that has not been imaged on the document table 3 and performs an operation on the scan button 80 for receiving the acquisition of a captured image which is a still image.

The CPU 11a performs imaging on the document table 3 on which the document is placed, on the basis of an instruction from the user (Step S103). Therefore, a captured image obtained by imaging the document table 3 on which the document is placed is acquired.

Then, the CPU 11a extracts and acquires a document image, which is a portion in which the document is read, from the captured image (Step S104).

Then, the CPU 11a stores information related to the document image in the secondary storage unit 12 (Step S105). Specifically, the CPU 11a stores information related to the position of the document image extracted and acquired from the captured image and the document image in the secondary storage unit 12.

Then, in the present exemplary embodiment, the CPU 11a performs a document detection process (Step S106). Specifically, the CPU 11a analyzes the document table video 70 obtained by the camera 5 and determines whether or not the imaged document remains on the document table 3.

Here, for example, in a case in which the position of the corresponding image 71 included in the document table video 70 is matched with the position of the document image included in the captured image obtained by imaging the document table 3, the CPU 11a determines that the document remains on the document table 3 and detects the imaged document.

In addition, for example, in a case in which an image that is formed in the corresponding image 71 included in the document table video 70 is matched with an image that is formed in the document image included in the captured image, the CPU 11a may determine that the document remains on the document table 3 and detect the imaged document.

In a case in which the imaged document is detected (YES in Step S106), the CPU 11a performs a notification process of notifying the user that the imaged document remains on the document table 3 (Step S107).

Then, the information represented by the reference numeral 7A in FIGS. 3B, 4B, and 6B or the image represented by the reference numeral 7B is displayed on the display device 7.

In addition, in a case in which the imaged document is detected, the CPU 11a does not display the scan button 80 for receiving a new imaging instruction from the user.

The CPU 11a performs the notification process and performs the process of not displaying the scan button 80 until the user removes the imaged document or reverses the front and back sides of the imaged document.

On the other hand, in a case in which the imaged document is not detected (NO in Step S106), the CPU 11a performs new imaging on the document table 3 on the basis of the instruction of the user received through the scan button 80 (Step S108). Specifically, the CPU 11a performs new imaging on the document table 3 on which a new document is placed on the basis of the instruction of the user. Therefore, a new captured image obtained by newly imaging the document table 3 is acquired.

Then, the CPU 11a extracts and acquires a new document image, which is a portion in which the new document is read, from the new captured image (Step S109).

Then, similarly to the above, the CPU 11a stores information related to the new document image in the secondary storage unit 12 (Step S110).

Then, the CPU 11a determines whether or not to end the imaging of the document table 3 by the camera 5 (Step S111).

Specifically, for example, in a case in which the user performs an operation on the end button 90 for receiving the end of the imaging of the document table 3 by the camera 5, it is determined that the imaging of the document table 3 by the camera 5 is ended. In a case in which the user does not perform an operation on the end button 90, it is determined that the imaging of the document table 3 by the camera 5 is continued.

In addition, for example, in a case in which a predetermined period of time has elapsed in a state in which the user does not operate the scan button 80 after a new captured image is acquired, it is determined that the imaging of the document table 3 by the camera 5 is ended. In a case in which the time is within the predetermined period of time, it is determined that the imaging of the document table 3 by the camera 5 is continued.

In a case in which the imaging of the document table 3 by the camera 5 is continued (NO in Step S111), the CPU 11a repeats the processes in Step S106 and the subsequent steps until the imaging of the document table 3 by the camera 5 is ended.

In Step S111, the CPU 11a ends the process in a case in which the imaging of the document table 3 by the camera 5 is ended (YES in Step S111).

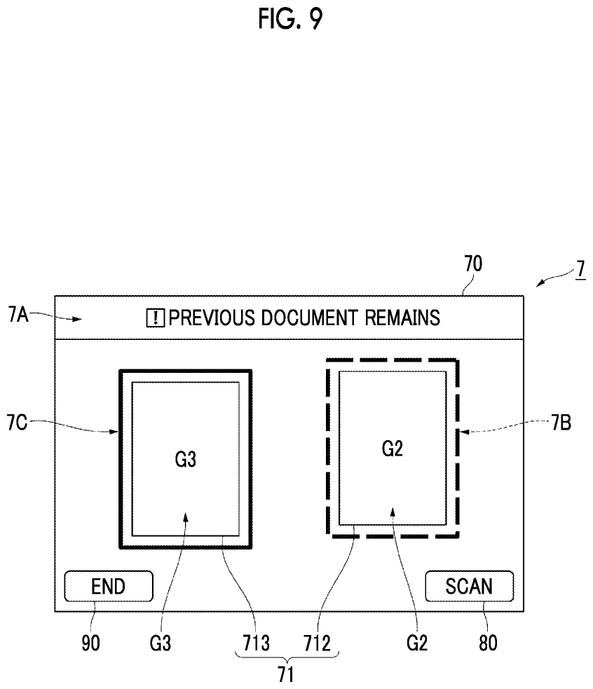

FIG. 9 (a diagram showing another example of the display of the display device 7) is a diagram showing another process different from the above process.

In the example of the display shown in FIG. 9, the document table video 70 includes a corresponding image 712 corresponding to the imaged document G2 and a corresponding image 713 corresponding to the new document G3.

Even in this example of the process, the imaged document G2 is detected from the document table video 70 by the same process as described above.

Specifically, in a case in which the position of the document image of the document G2 stored in the secondary storage unit 12 is matched with the position of the corresponding image 712 included in the document table video 70 obtained in real time, the CPU 11a detects the document G2 that remains on the document table 3.

Here, “the match between the positions” is not limited to perfect match, which is not described above.

In the present exemplary embodiment, in a case in which the position of the document image stored in the secondary storage unit 12 is different from the position of the corresponding image 712 included in the document table video 70 obtained in real time, but the degree of difference is less than a predetermined threshold value, the CPU 11a determines that the position of the document image is matched with the position of the corresponding image 712.

It is assumed that an error occurs in reading by the camera 5 or a situation in which the document is moved slightly occurs. In the present exemplary embodiment, in this case, it is determined that the positions are matched with each other.

An example of the process shown in FIG. 9 will be described.

Even in the example of the process shown in FIG. 9, similarly to the above, a notification informing the user that the imaged document G2 remains on the document table 3 is issued.

On the other hand, in this example of the process, unlike the above-described process, the scan button 80 for receiving a new imaging instruction from the user is displayed on the display device 7.

In the process shown in FIG. 9, even in a case in which the imaged document G2 remains on the document table 3, the scan button 80 is displayed such that the user can issue a new imaging instruction.

Accordingly, in this case, even in a case in which the imaged document G2 is not removed, the new document G3 can be imaged together with the imaged document G2.

In a case in which the new document G3 can be imaged together with the imaged document G2, a captured image obtained by imaging the document table 3 on which the imaged document G2 and the new document G3 are placed is acquired.

In this case, the captured image includes a document image which is a portion in which the imaged document G2 is read and a new document image which is a portion in which the new document G3 is read.

In this example of the process described with reference to FIG. 9, for the new document G3, the document image of the new document G3 is extracted and acquired from the captured image. Further, in this case, information related to the position of the document image of the document G3 or the document image of the document G3 is stored in the secondary storage unit 12.

For the document G2, only the position of the document image of the document G2 is extracted and acquired. Then, information related to the position of the document image of the document G2 is stored in the secondary storage unit 12.

In the present exemplary embodiment, as described above, in order to determine whether or not the imaged document remains on the document table 3 on the basis of the position of the document image, information related to the position of the document image used for this determination is stored.

Here, in the present exemplary embodiment, the information related to the position of the document image of the document G2 is stored in the secondary storage unit 12 a plurality of times.

Specifically, in the present exemplary embodiment, in both a case in which first imaging is performed in a state in which the document G2 is first placed and a case in which second imaging is performed in a state in which the captured image of the document G2 has already been acquired, information related to the position of the document image of the document G2 is acquired and stored.

Here, information obtained by the first imaging may be continuously used as the information related to the position of the document image of the document G2. However, in the present exemplary embodiment, whenever the document G2 is imaged, the information related to the position is updated.

It is assumed that the document G2 is moved slightly whenever the document is imaged.

In addition, it is assumed that the position of the document changes whenever the document is imaged.

In a case in which it is determined whether or not the position of the document G2 placed on the document table 3 is matched with the position of the past document image on the basis of the position of the document image obtained by the first imaging, it is likely that the document G2 placed on the document table 3 is determined to be another document different from the document corresponding to the past document image.

In the present exemplary embodiment, in a case in which the imaging of the document G2 is repeated a plurality of times, the position of the document G2 may gradually shift, and the amount of positional deviation may increase. In a case in which the position of the document image obtained by the first imaging is used as a reference, the amount of deviation from the reference increases, and it is likely that the document G2 placed on the document table 3 is determined to be another document different from the document corresponding to the past document image.

On the other hand, in a case in which the information related to the position of the document image of the document G2 is updated whenever the document G2 is imaged, it is unlikely that the document G2 placed on the document table 3 is determined to be another document.

Therefore, the following situation is less likely to occur: even though the imaged document G2 is placed on the document table 3, the document G2 is determined to be another document different from the document G2, and it is not detected that the imaged document G2 remains on the document table 3.

Further, another example of the process will be described.

A case in which the document table 3 on which the document is placed is imaged on the basis of the selection of the scan button 80 by the user has been described above as an example.

The present disclosure is not limited thereto. In a case in which predetermined conditions are satisfied, the document table 3 on which the document is placed may be automatically imaged.

For example, in a case in which the document placed on the document table 3 is stationary for a predetermined period of time or longer, the document table 3 on which the document is placed may be automatically imaged.

Further, in the automatic imaging, in a case in which the imaged document still remains on the document table 3, the document table 3 may not be automatically imaged.

In the above description, in a case in which the imaged document still remains on the document table 3, the scan button 80 is not displayed such that new imaging is not performed. In the case of the automatic imaging, new imaging is not automatically performed.

In addition, in the automatic imaging, for example, in a case in which a document that has been imaged and a document that has not been imaged are placed on the document table 3, the automatic imaging may be performed. In other words, in a case in which the document that has not been imaged is placed on the document table 3, the automatic imaging may be performed even though the imaged document remains on the document table 3.

In a case in which the automatic imaging is performed even though the imaged document is placed on the document table 3, for the document that has not been imaged, the document image of the document that has not been imaged is extracted and acquired from the captured image.

Further, in this case, information related to the position of the document image corresponding to the document that has not been imaged or the document image of the document that has not been imaged is stored in the secondary storage unit 12.

In addition, for the imaged document, only the position of the document is extracted and acquired. Then, information related to the position of the document image of the imaged document is stored in the secondary storage unit 12.

Even in a case in which the document table 3 is automatically imaged in a state in which the imaged document remains on the document table, for example, a notification informing the user that the imaged document remains on the document table 3 is preferably issued in the same manner as described above.

Further, in a case in which the automatic imaging is performed even though the imaged document is placed on the document table 3, a notification informing the user that the document image of the imaged document is not stored in the secondary storage unit 12 may also be issued.

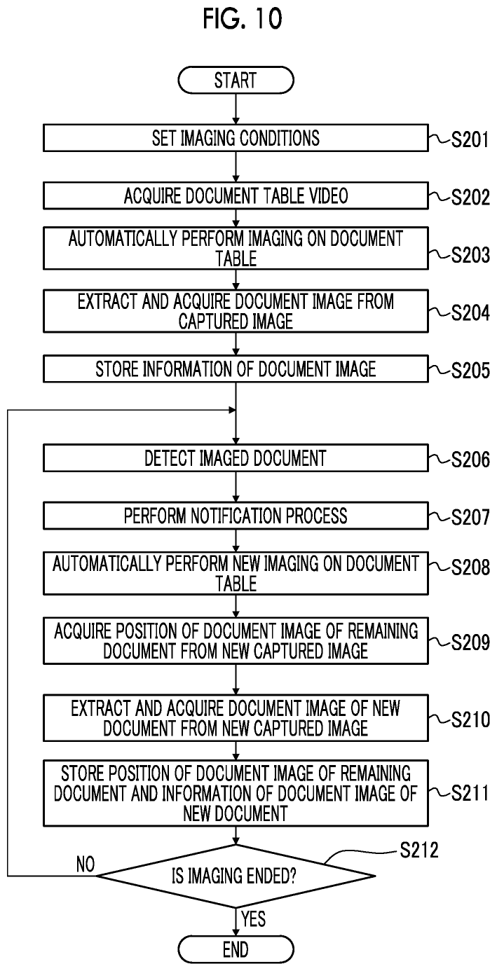

FIG. 10 is a flowchart showing a flow of a process in a case in which the automatic imaging is performed even though the imaged document is placed on the document table 3.

In addition, FIG. 10 shows a flow of a process from a situation in which no document is placed on the document table 3.

Even in this example of the process, first, the CPU 11a receives the setting of imaging conditions (Step S201) and starts to acquire the document table video 70 (Step S202). Therefore, the document table video 70 is displayed on the display device 7.

Then, in this example of the process, the user places the document that has not been imaged on the document table 3.

Then, in a case in which the state of the document table 3 satisfies automatic imaging conditions, the document table 3 on which the document is placed is automatically imaged (Step S203).

Specifically, in a case in which the document is placed on the document table 3 and is stationary, the CPU 11a determines that the state of the document table 3 satisfies the automatic imaging conditions and performs first imaging on the document table 3. Therefore, a captured image obtained by imaging the document table 3 on which the document is placed is acquired.

Then, the CPU 11a extracts and acquires a document image from the captured image in the same manner as described above (Step S204) and stores information related to the document image obtained by the first imaging in the secondary storage unit 12 (Step S205).

Then, in this example of the process, a case in which the user places a new document on the document table 3 without removing the imaged document is assumed.

In this case, since the imaged document remains, the CPU 11a performs a process of detecting the imaged document (Step S206).

Further, in the specification, hereinafter, the document that has been imaged and is not removed is referred to as a “remaining document”, and the new document is referred to as a “new document”.

Then, the CPU 11a performs a notification process of notifying the user that the remaining document remains on the document table 3 (Step S207) and automatically performs new imaging on the document table 3 satisfying the automatic imaging conditions (Step S208).

For example, in a case in which the remaining document and the new document are stationary, the CPU 11a performs display indicating that the remaining document remains on the document table 3 on the display device 7 and then performs new automatic imaging. In other words, second imaging is automatically performed.

Therefore, a new captured image obtained by imaging the document table 3 on which the remaining document and the new document are placed is acquired.

Then, the CPU 11a extracts and acquires the position of a document image, which is a portion in which the remaining document is read, from the new captured image obtained by the second imaging (Step S209).

In addition, the CPU 11a extracts and acquires a document image, which is a portion in which the new document is read, from the new captured image obtained by the second imaging (Step S210).

Then, the CPU 11a stores information related to the position of the document image of the remaining document and information related to the document image of the new document in the secondary storage unit 12 (Step S211). Specifically, the CPU 11a stores the information related to the position of the document image of the remaining document, the information related to the position of the document image of the new document, and the document image of the new document in the secondary storage unit 12.

Therefore, in the information related to the document images stored in the secondary storage unit 12, the information related to the position of the document image of the remaining document is updated.

In addition, for the document image of the new document, the information related to the position of the document image of the new document is registered.

Then, the CPU 11a determines whether or not to end the imaging of the document table 3 by the camera 5 (Step S212).

In a case in which the CPU 11a continues the imaging of the document table 3 by the camera 5 (NO in Step S212), the CPU 11a repeats the processes in Step S206 and the subsequent steps until the imaging of the document table 3 by the camera 5 is ended.

In a case in which the CPU 11a ends the imaging of the document table 3 by the camera 5 in Step S212 (YES in Step S212), the CPU 11a ends the process.

Further, still another example of the process will be described.

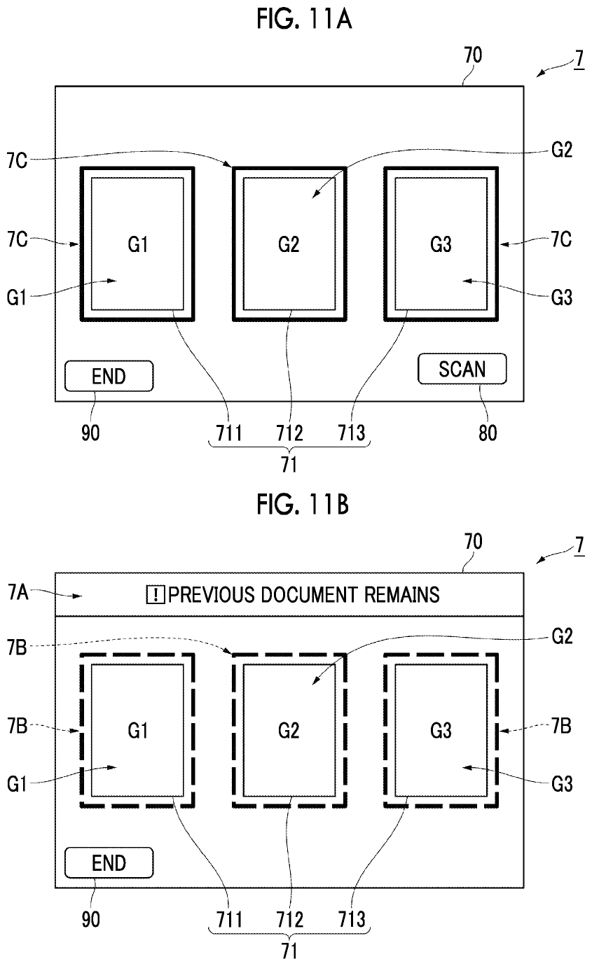

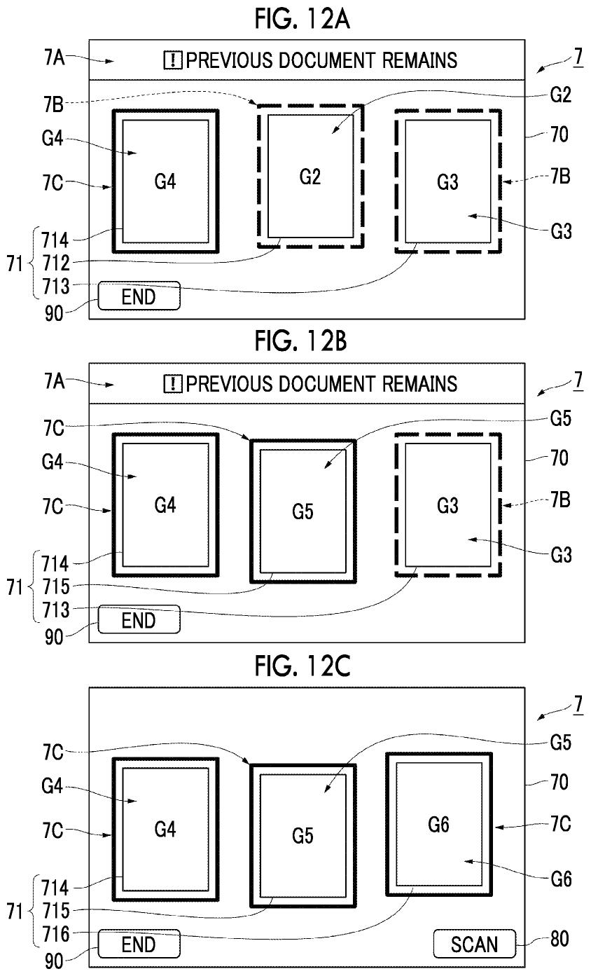

FIGS. 11A and 11B and FIGS. 12A to 12C (diagrams showing still another example of the display of the display device 7) are diagrams showing a process in a case in which three or more documents are read at once.

In this example of the process, a case in which documents G1, G2, and G3 are imaged and then documents G4, G5, and G6 are imaged is given as an example.

In this example of the process, first, the documents G1, G2, and G3 are placed on the document table 3 (see FIG. 1) by the user, and the document table video 70 is in the state shown in FIG. 11A.

Then, in this example of the process, the documents G1, G2, and G3 are imaged.

Then, even in this example of the process, as shown in FIG. 11B, the imaged documents G1, G2, and G3 are detected from the document table video 70 by the same process as described above. Then, a notification informing the user that the imaged documents remain is issued, and the scan button 80 is not displayed.

Then, the user sequentially replaces the imaged documents G1, G2, and G3 with the new documents G4, G5, and G6.

In the state shown in FIGS. 12A and 12B, the replacement of the documents has not been completed, and the imaged documents G2 and G3 remain on the document table 3. Therefore, the notification informing the user that the imaged documents remain is maintained.

In the state shown in FIG. 12C, since the replacement of the documents has been completed, the scan button 80 is displayed such that the user can issue a new imaging instruction.

Therefore, the new documents G4, G5, and G6 can be imaged.

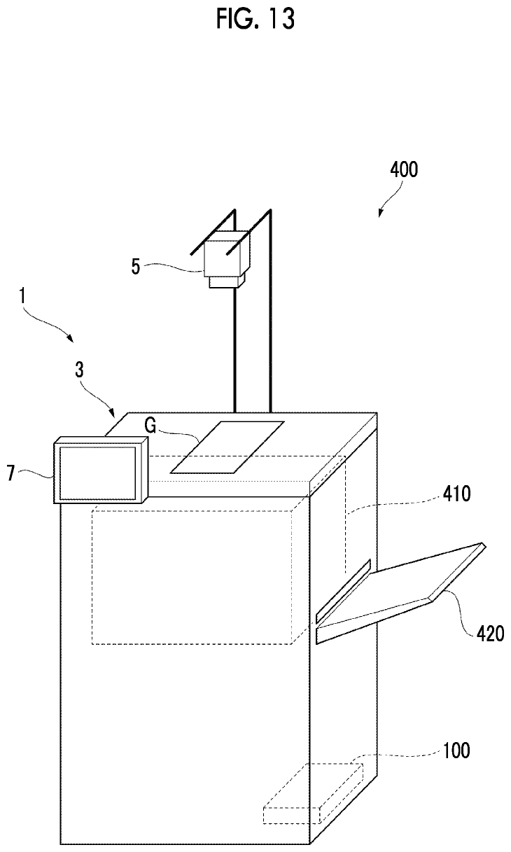

FIG. 13 is a diagram showing an image forming apparatus 400.

As shown in FIG. 13, the image reading apparatus 1 may be provided as a portion of the image forming apparatus 400.

In the image forming apparatus 400, the image reading apparatus 1 described above is provided in an upper portion of the image forming apparatus 400.

Similarly to the above, the image reading apparatus 1 is provided with the document table 3 that supports the document G from below, the camera 5 that images the document G placed on the document table 3, and the display device 7 that displays information to the user. Further, the image forming apparatus 400 is provided with the information processing apparatus 100 that processes information related to the imaging of the document G.

In addition, an image forming unit 410 that forms an image on a recording material, such as paper, is provided in the image forming apparatus 400.

The image forming unit 410 forms an image on the recording material supplied from a recording material accommodation unit (not shown) or the like, using an inkjet method, an electrophotographic method, or the like.

Specifically, the image forming unit 410 forms an image on the recording material on the basis of the captured image obtained by the image reading apparatus 1 or image data transmitted from the outside of the image forming apparatus 400 to the image forming apparatus 400, using the inkjet method, the electrophotographic method, or the like.

The recording material having the image formed thereon is transported to a paper loading unit 420 and loaded on the paper loading unit 420.

Supplementary Note

(((1)))

An information processing system comprising:
one or more processors configured to:
   acquire a document table video that is a video of a document table on which a document is placed and is obtained by an imaging device after the imaging device images the document table; and
   in a case in which the document table video includes an imaged document that is a document having been imaged by the imaging device, detect the imaged document.

(((2)))

The information processing system according to (((1))), wherein the one or more processors are configured to:
perform a process of making a user recognize that the imaged document remains in a case in which the imaged document is detected.

(((3)))

The information processing system according to (((2))), wherein the one or more processors are configured to:
perform display for notifying the user that the imaged document placed on the document table remains on the document table on a display unit as the process of making the user recognize that the imaged document remains.

(((4)))

The information processing system according to (((1))), wherein the one or more processors are configured to:
in a case in which a new document is placed on the document table in a state in which the document table video includes the imaged document and the imaged document remains on the document table, perform identifiable display for enabling a user to identify the imaged document and the new document on a display unit.

(((5)))

The information processing system according to (((4))), wherein the one or more processors are configured to:
perform display such that a display aspect of the imaged document is different from a display aspect of the new document as the identifiable display.

(((6)))

The information processing system according to any one of (((1))) to (((5))), wherein the one or more processors are configured to:
allow acquisition of a document image that is a portion including the document from a captured image obtained by imaging the document table on which the document is placed with the imaging device, and
prevent the acquisition of the document image of the imaged document in a case in which the captured image is obtained in a state in which the document table video includes the imaged document and the imaged document remains on the document table.

(((7)))

The information processing system according to any one of (((1))) to (((5))), wherein the one or more processors are configured to:
prevent new imaging of the document table by the imaging device in a case in which the document table video includes the imaged document and the imaged document is detected.

(((8)))

The information processing system according to any one of (((1))) to (((5))), wherein the one or more processors are configured to:
in a case in which the imaging device images the document table to acquire a new captured image in a state in which the document table video includes the imaged document, the imaged document remains on the document table, and a new document is placed on the document table, make a process that is performed on a portion including the imaged document in the new captured image different from a process that is performed on a portion including the new document in the new captured image.

(((9)))

The information processing system according to any one of (((1))) to (((8))), wherein the one or more processors are configured to:
perform a process of detecting the imaged document on the basis of a position of an image included in a captured image obtained by imaging the document table on which the document is placed with the imaging device and a position of an image included in the document table video obtained by the imaging device after the imaging device images the document table on which the document is placed.

(((10)))

The information processing system according to (((9))), wherein the one or more processors are configured to:
detect the imaged document in a case in which the position of the image included in the captured image is matched with the position of the image included in the document table video.

(((11)))

The information processing system according to any one of (((1))) to (((10))), wherein the one or more processors are configured to:
perform a process of detecting the imaged document on the basis of an image included in a captured image obtained by imaging the document table on which the document is placed with the imaging device and an image included in the document table video obtained by the imaging device after the imaging device images the document table on which the document is placed.

(((12)))

The information processing system according to (((11))), wherein the one or more processors are configured to:
detect the imaged document in a case in which the image included in the captured image is matched with the image included in the document table video.

(((13)))

An image reading apparatus comprising:
an apparatus that images a document table on which a document is placed with an imaging device and reads an image of the document; and an information processing system that processes information related to the apparatus, wherein the information processing system is configured to include the information processing system according to any one of (((1))) to (((12))).

(((14)))

An image forming apparatus comprising:
an apparatus that images a document table on which a document is placed with an imaging device and reads an image of the document;
an information processing system that processes information related to the apparatus; and
an image forming unit that forms an image on a recording material,
wherein the information processing system is configured to include the information processing system according to any one of (((1))) to (((12))).

(((15)))

A program that causes a computer to implement:
a function of acquiring a document table video that is a video of a document table on which a document is placed and is obtained by an imaging device after the imaging device images the document table; and
a function of, in a case in which the document table video includes an imaged document that is a document having been imaged by the imaging device, detecting the imaged document.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
one or more processors configured to:
acquire a document table video that is a video of a document table on which a document is placed and is obtained by an imaging device after the imaging device images the document table; and
in a case in which the document table video includes an imaged document that is a document having been imaged by the imaging device, detect the imaged document.

2. The information processing system according to claim 1, wherein the one or more processors are configured to:
perform a process of making a user recognize that the imaged document remains in a case in which the imaged document is detected.

3. The information processing system according to claim 2, wherein the one or more processors are configured to:
perform display for notifying the user that the imaged document placed on the document table remains on the document table on a display unit as the process of making the user recognize that the imaged document remains.

4. The information processing system according to claim 1, wherein the one or more processors are configured to:
in a case in which a new document is placed on the document table in a state in which the document table video includes the imaged document and the imaged document remains on the document table, perform identifiable display for enabling a user to identify the imaged document and the new document on a display unit.

5. The information processing system according to claim 4, wherein the one or more processors are configured to:
perform display such that a display aspect of the imaged document is different from a display aspect of the new document as the identifiable display.

6. The information processing system according to claim 1, wherein the one or more processors are configured to:
allow acquisition of a document image that is a portion including the document from a captured image obtained by imaging the document table on which the document is placed with the imaging device, and
prevent the acquisition of the document image of the imaged document in a case in which the captured image is obtained in a state in which the document table video includes the imaged document and the imaged document remains on the document table.

7. The information processing system according to claim 2, wherein the one or more processors are configured to:
allow acquisition of a document image that is a portion including the document from a captured image obtained by imaging the document table on which the document is placed with the imaging device, and
prevent the acquisition of the document image of the imaged document in a case in which the captured image is obtained in a state in which the document table video includes the imaged document and the imaged document remains on the document table.

8. The information processing system according to claim 3, wherein the one or more processors are configured to:
allow acquisition of a document image that is a portion including the document from a captured image obtained by imaging the document table on which the document is placed with the imaging device, and
prevent the acquisition of the document image of the imaged document in a case in which the captured image is obtained in a state in which the document table video includes the imaged document and the imaged document remains on the document table.

9. The information processing system according to claim 4, wherein the one or more processors are configured to:
allow acquisition of a document image that is a portion including the document from a captured image obtained by imaging the document table on which the document is placed with the imaging device, and
prevent the acquisition of the document image of the imaged document in a case in which the captured image is obtained in a state in which the document table video includes the imaged document and the imaged document remains on the document table.

10. The information processing system according to claim 5, wherein the one or more processors are configured to:
allow acquisition of a document image that is a portion including the document from a captured image obtained by imaging the document table on which the document is placed with the imaging device, and
prevent the acquisition of the document image of the imaged document in a case in which the captured image is obtained in a state in which the document table video includes the imaged document and the imaged document remains on the document table.

11. The information processing system according to claim 1, wherein the one or more processors are configured to:
prevent new imaging of the document table by the imaging device in a case in which the document table video includes the imaged document and the imaged document is detected.

12. The information processing system according to claim 2, wherein the one or more processors are configured to:
prevent new imaging of the document table by the imaging device in a case in which the document table video includes the imaged document and the imaged document is detected.

13. The information processing system according to claim 3, wherein the one or more processors are configured to:
prevent new imaging of the document table by the imaging device in a case in which the document table video includes the imaged document and the imaged document is detected.

14. The information processing system according to claim 1, wherein the one or more processors are configured to:
in a case in which the imaging device images the document table to acquire a new captured image in a state in which the document table video includes the imaged document, the imaged document remains on the document table, and a new document is placed on the document table, make a process that is performed on a portion including the imaged document in the new captured image different from a process that is performed on a portion including the new document in the new captured image.

15. The information processing system according to claim 1, wherein the one or more processors are configured to:
perform a process of detecting the imaged document on the basis of a position of an image included in a captured image obtained by imaging the document table on which the document is placed with the imaging device and a position of an image included in the document table video obtained by the imaging device after the imaging device images the document table on which the document is placed.

16. The information processing system according to claim 15, wherein the one or more processors are configured to:
detect the imaged document in a case in which the position of the image included in the captured image is matched with the position of the image included in the document table video.

17. The information processing system according to claim 1, wherein the one or more processors are configured to:
perform a process of detecting the imaged document on the basis of an image included in a captured image obtained by imaging the document table on which the document is placed with the imaging device and an image included in the document table video obtained by the imaging device after the imaging device images the document table on which the document is placed.

18. The information processing system according to claim 17, wherein the one or more processors are configured to:
detect the imaged document in a case in which the image included in the captured image is matched with the image included in the document table video.

19. An image reading apparatus comprising:
an apparatus that images a document table on which a document is placed with an imaging device and reads an image of the document; and
one or more processors that process information related to the apparatus,
wherein the one or more processors are configured to:
acquire a document table video that is a video of the document table on which the document is placed and is obtained by the imaging device after the imaging device images the document table; and
in a case in which the document table video includes an imaged document that is a document having been imaged by the imaging device, detect the imaged document.

20. A non-transitory computer readable medium storing a program that causes a computer to implement:
a function of acquiring a document table video that is a video of a document table on which a document is placed and is obtained by an imaging device after the imaging device images the document table; and
a function of, in a case in which the document table video includes an imaged document that is a document having been imaged by the imaging device, detecting the imaged document.
